(19) United States
(12) Patent Application Publication
(10) Pub. No.: US 2013/0186711 A1
(43) Pub. Date: Jul. 25, 2013

(54) Modified Vector Dynamics 2

(71) Applicant: Ivan D. Alexander, Costa Mesa, CA (US)

(72) Inventor: Ivan D. Alexander, Costa Mesa, CA (US)

(21) Appl. No.: 13/216,082

(22) Filed: Jan. 25, 2012

(51) Int. Cl. F03G 3/00

(52) U.S. Cl. 185/27; 74/DIG. 9

(57) ABSTRACT

Gyroscopic precession is the result of angular velocity of rotation and angular velocity produced by torque which acted upon by vector force of gravity will cause precession. The resulting precessional vector force at right angle to torque is currently well understood, though not understood how this precession vector can be modified by right angle to produce the same force as a directed vector force; how angular momentum could be made directional. Inventor shows in principle how this Earth gravity G-force is re-directed using gyroscopic action housed within a larger apparatus, when whole apparatus is spun in either direction, whereby the angular momentum is transferred along the axis of spin. The result is a directional force caused by acceleration of spin of whole apparatus, which may be a usable force in future propulsion systems.

### CROSS REFERENCED TO RELATED APPLICATION

This current application replaces the prior filing of U.S. Provisional Patent application 13/216,082 filed on Aug. 23, 2011.

### FIELD OF INVENTION

The present invention relates to the apparatus using counter-spinning mass housed within an external sphere to re-direct Earth's gravity from natural lateral precession into a vector along the axis vertical force. This new directional force can then move the whole apparatus along its axis by using the MOVED G-force to effect a utilitarian force. Based on this principle can be designed future motors for propulsion in any medium, including space.

### ABSTRACT

Gyroscopic precession is the result of angular velocity of rotation and angular velocity produced by torque, which acted upon by the (downward) vector force of gravity will cause it to precess. The resulting precessional vector force at right angle to (moving in the direction of) torque is currently well understood and amply documented. What is not documented, nor perhaps understood, is how this precession vector can be modified by right angle to produce the same force as an either up or down vector force simulating either “lift” or “sink”, or how this angular momentum action could be made “directional”. Inventor will show how, in principle, this Earth gravity G-force can be re-directed using gyroscopic action housed within a larger apparatus, when the whole apparatus is spun in either direction, whereby the angular momentum is transferred along the axis of spin. The result is a directional force caused by acceleration of spin of whole apparatus, which may be a usable force in future propulsion systems.

### SUMMARY OF INVENTION

Gyroscopic action principle has been used successfully for purposes of vehicle stabilization and alignment. This new motor is designed to use the same gyroscopic principle, commonly called “conservation of momentum”, to re-direct it into its vector equivalent along the axis of spin. This is same principle, in effect, as illustrated by tying a spinning gyroscope to a string and then twirling the string either clock-wise or counter-clock-wise to effect the gyroscope's “rise” or “fall” at the end of its tether, though results will be shown opposite. When two gyroscopes, spinning in same direction, are attached perpendicular to the axis of a larger sphere apparatus, pointing opposite so their precessional force cancels out, their precessional motion can be re-directed along the whole apparatus's axis, in either direction depending upon direction of spin, so a force results that moves the apparatus in such direction. This is the underlying principle of the Modified Vector Dynamics G-force motor, whereby Earth's gravity captured by gyroscopic action, what results in natural lateral precession, is now made perpendicular to the whole apparatus's natural precession. It has been found that a small force results, one that could be amplified by design, so that actual motion along the axis results. For right spinning gyroscopes, clockwise spin, the natural precession is counter-clockwise for the whole apparatus; when the apparatus has force applied to accelerate it to spin in direction of precession, counter-clockwise, the result will be an axial force in one direction, while spun counter to precession, clockwise, the resulting force will be in the opposite direction. For an upright axis of whole apparatus, added counter-clockwise will make it ‘heavier’ by fractional kilogram; whereas if spun clockwise, it will be ‘lighter’ by fractional kilogram. Tests have demonstrated that if above described (right spinning counter-balanced gyroscopes enclosed) apparatus axis is horizontal to Earth's gravity, counter-clockwise spin will move it to the right, whereas clockwise spin would move it to the left. Though effect is still small, it demonstrates the principle involved, which is totally Newtonian, where Earth's natural G-force enters the system and manifests as gyroscopic action, which in turn with accelerative-force added to effect spin of the whole apparatus, a momentary G-force induced reaction will be vectored along the axis of the whole apparatus. Upon this principle is what powers the Modified Vector Dynamics motor. To gain full effect of this motor, a constant pulse of accelerative force must be added continuously to gyroscopic action, if the re-directed vector motion is to be sustained. Further efficacy will be explored to amplify this MOVED G-force effect. It is the inventor's opinion that full efficacy will be achieved by substituting gyroscopes with multi-leveled bands of fluid, or dense gas, stimulated into fast spin with electro-magnetic pulses within the stacked bands, which are then rotated continuously, so a continuous re-directed vector force results to propel the motor in desired vector. This amplification may further be enhanced by microwave pulses (MASER) to turn fluid, or gas, into a fast rotating toroidal plasma within the rotating bands, which may greatly increase the gyroscopic effect. At this time, pending further research, it is not yet known what materials would work best for full and usable efficacy, but the basic principle of Modified Vector Dynamics is the same, to use Earth's G-force and redirect it along the motor's axis.

### DESCRIPTION OF DRAWINGS

FIG. 1, demonstrates the basic gyroscopic action housed within a spin induced motor. The motor axis (1) is shown horizontal to the Earth plane, with two right-spin gyroscopes (2) perpendicular to such axis powered by electric motors (3). The enveloping housing (4) has angular force added to spin it in either right spin (5) or counter spin (6), so motion results perpendicular to motor's natural precession (7), vector-F directed along the axis (1).

FIG. 2, demonstrates envisioned MOVED G-force motor using stacked bands (8) attached to a supporting swivel rod (9), whereby inside each stacked bands is an electric magnet (10) over which is a fast rotating toroidal plasma (11). The electric pulses are made of three sets of alternating and continuous (A,B,C and D,E,F) activations. The motor is then rotated in toto (12) in chosen direction to re-direct the vector force (13) in direction desired.

### ADDITIONAL REMARKS

There is no new physics here, this is totally Newtonian. The added spin acceleration, with either mechanical or electric force, to the whole apparatus translates into a redirected vector force. It is the inventor's vision that three such MOVED G-force motors fastened inside a craft will give it triangulating motive power in any direction desired, both vertical and lateral motion, and full range in between by swiveling it. When the motor's efficacy is substantially enhanced to effectively use both the Earth's and Sun's gravitational forces, there is unlimited possibility for space travel with a continuous accelerative force to take us to destinations desired in a much shorter period of time than now achieved with chemical reaction rocket engines. In effect, this is ‘gravity on board’ our space crafts to simulate what are now ‘gravity assist’ maneuvers, to take us to distant bodies in space, both in our solar system and out.

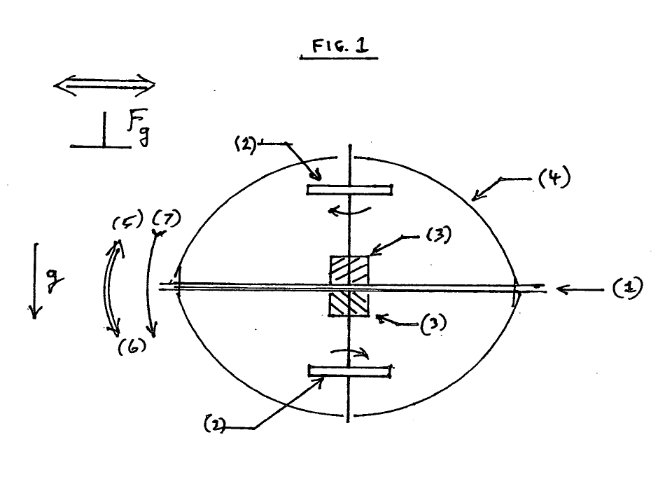

1. This propulsion assist power objective is met with the Modified Vector Dynamics (MOVED) G-force, per invention FIG. 1, applied to a motor with sustained pulse acceleration directed along the axis of spin of the whole apparatus, so a resulting re-directed vector force moves the vehicle in a dedicated manner, along motor axis, to enhance propulsion in the direction desired.

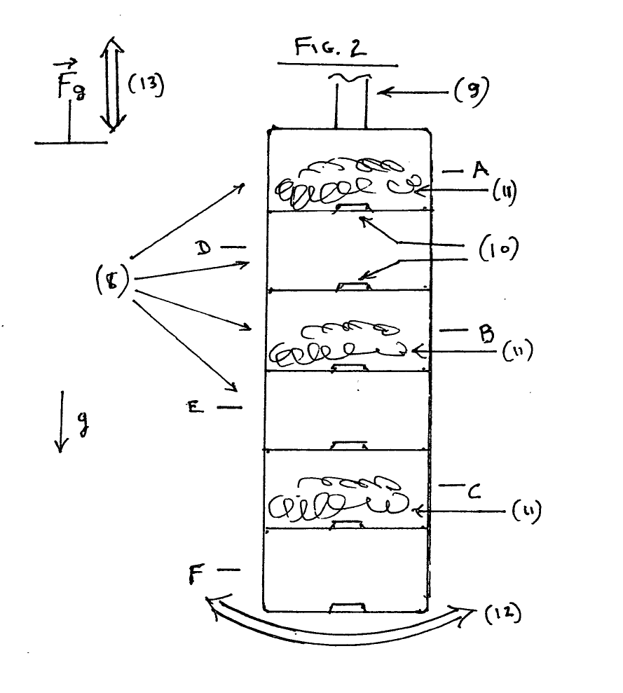

2. When this motor is taken to full efficacy, per invention FIG. 2, the “assist-power” would become “full-power”, which would enable the motor to work at its best capacity as a stand alone power source of motion and lift in future vehicles.
